(19) United States
(12) Patent Application Publication
(10) Pub. No.: US 2026/0238296 A1
(43) Pub. Date: Aug. 13, 2026

(54) MULTIPLE ANTENNA SPATIAL PARTITION CYCLING FOR NETWORK ENERGY SAVINGS

(71) Applicant: Nokia Technologies Oy, Espoo (FI)

(72) Inventors: John HARRIS, Shorewood, WI (US); Matha DEGHEL, Massy (FR)

(21) Appl. No.: 19/154,265

(22) PCT Filed: Nov. 23, 2023
(86) PCT No.: PCT/EP2023/082772

§ 371 Date: Aug. 6, 2025

Related U.S. Application Data
(60) Provisional application No. 63/485,369, filed on Feb. 16, 2023.

(51) Int. Cl. H04B 7/06; H04W 52/02

(52) U.S. Cl. CPC H04B 7/0695; H04B 7/0608; H04W 52/0203

(57) ABSTRACT

A method of operating a node in a network such that the node sets at least one configuration of a spatial element cycle set such that the spatial element cycle set includes a plurality of partitions, and such that each partition of the plurality of partitions includes a level of active spatial elements different from a level of the active spatial elements in at least one other of the plurality of partitions; repeatedly cycles through the spatial element cycle set; and transmits parameters for the configuration of the spatial element cycle set to user equipment (UE).

### TECHNICAL FIELD

One or more example embodiments generally relate to a method of improving energy savings and reducing the energy requirements for networks and, more particularly, to component cycling for energy savings.

### BACKGROUND

Developments in network architecture, such as the 5^{th} Generation (5G) mobile, have been made in order to meet the increasing demand for improved services and higher data rates. Such developments often require higher density of antennas, larger bandwidths, more frequency bands, and/or the like. Such demand has also increased the energy usage systems which rely on such networks.

Turning off and/or muting such components of base stations in the network may enable base station power saving but may also result in a reduction in performance.

### SUMMARY

At least one example embodiment relates to a method of operating a node in a network.

One or more example embodiments may be directed towards a method of operating a node in a network and processing circuitry configured to perform the method. The method may include: setting at least one configuration of a spatial element cycle set such that the spatial element cycle set includes a plurality of partitions, such that each partition of the plurality of partitions includes a level of active spatial elements different from a level of the active spatial elements in at least one other of the plurality of partitions; repeatedly cycling through the spatial element cycle set; and transmitting parameters for the configuration of the spatial element cycle set to user equipment (UE).

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram of an example system in which the example embodiments may be practiced.

FIG. 2 illustrates an example repetition of cycling through spatial element cycle sets.

FIG. 3 illustrates an example repetition of cycling through spatial element cycle sets.

FIG. 4 illustrates an example of signaling between user equipment (“UE”) and a base station (“gNB”).

FIG. 5 is a flow chart illustrating a method of establishing the operation of components in a base station.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

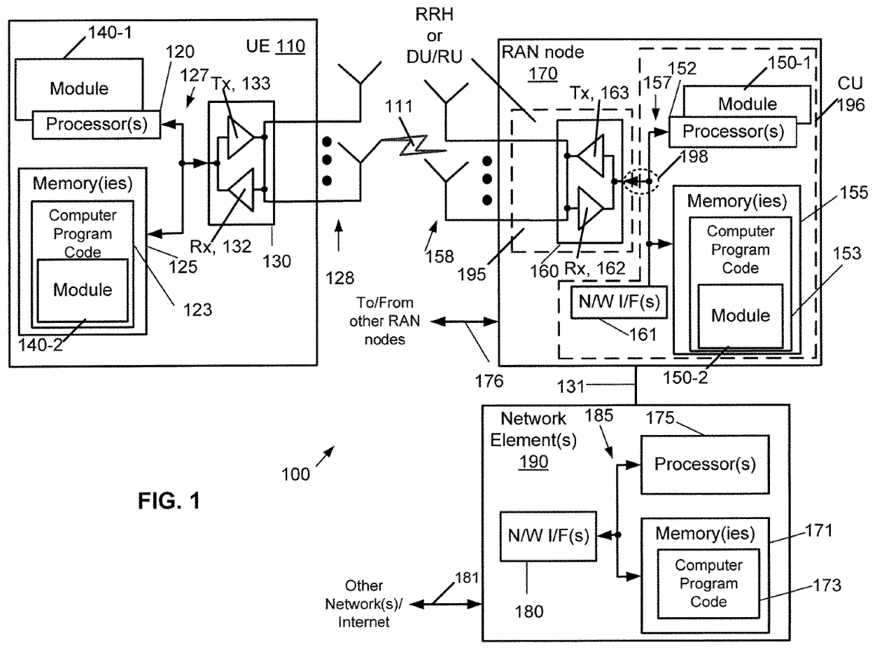

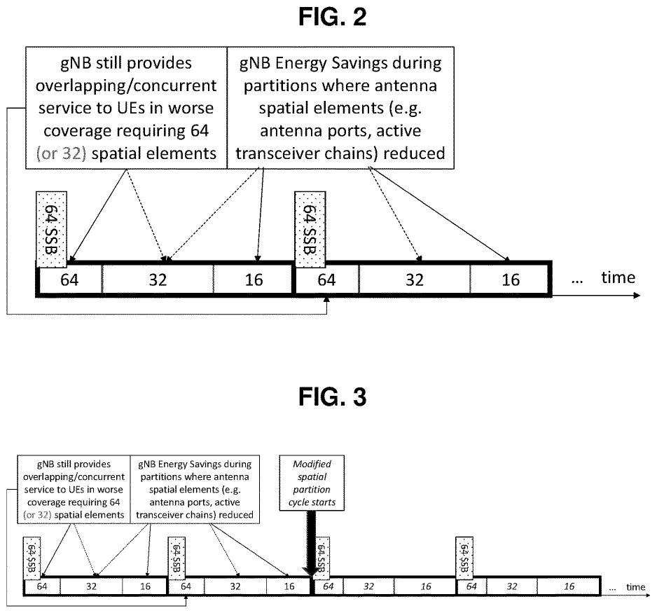

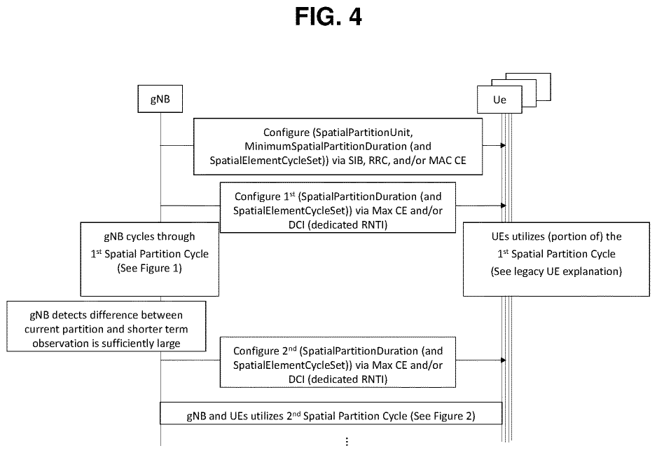

FIG. 1 is a block diagram of an example system in which the example embodiments may be practiced. The system may include at least one user equipment (UE) 110, at least one radio access network (RAN) node 170, and network element(s) 180. The UE 110 may represent, e.g., wireless communication devices that can access a wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a next generation (NG)-RAN node, which may be defined as, e.g., either a next generation Node B (gNB) or a next generation evolved Node B (ng-eNB). For example, a gNB is a node providing new radio (NR) user plane and control plane protocol terminations towards the UE and connected via the NG interface to a 5G core network (5GC) (such as, for example, the network element(s) 190). The ng-eNB is a node providing evolved universal terrestrial radio access (E-UTRA) user plane and control plane protocol terminations towards the UE and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown.

Note that the DU may include or be coupled to and control a radio unit (RU). The gNB-CU is a logical node hosting radio resource control (RRC), service data adaptation protocol (SDAP), and/or packet data convergence protocol (PDCP) protocols of the gNB and/or RRC and PDCP protocols of the en-gNB that controls the operation of one or more gNB-DUs. The gNB-CU terminates the F1 interface connected with the gNB-DU. The F1 interface is illustrated as included in reference 198, although reference 198 also illustrates a link between remote elements of the RAN node 170 and centralized elements of the RAN node 170, such as between the gNB-CU 196 and the gNB-DU 195.

The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360-degree area so that the single base station's coverage area covers an approximate oval or circle. Furthermore, each cell can correspond to a single carrier and a base station may use multiple carriers. So, if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190 and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g., CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g., cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, extended reality (XR), and/or the like, as well as portable units or terminals that incorporate combinations of such functions.

Features as described herein generally relate to network energy savings, for example in radio access networks, which generally consume the largest part of the total energy consumption in the network. Most of this energy consumption comes from the radio access network, in particular the Active Antenna Unit(s) (AAU(s)). More specifically, the power consumption of a radio access can be split into two parts: the dynamic part which is only consumed when data transmission/reception is ongoing, and the static part which is consumed all the time to maintain the necessary operation of the radio access devices, even when the data transmission/reception is not on-going. Additionally, where energy costs are estimated to be ~23% of the total operating expenses (OPEX) for networks, reducing the active energy costs of the network may substantially reduce the total costs of the operating the network. In the third-generation partnership projection (3GPP) release 18 work, RP-223540, aims at identifying adaption techniques of transmissions and/or receptions in time, frequency, spatial, and power domains, with potential support/feedback from UE. For example, network energy savings may be achieved with synchronization signal blocks (SSB) transmissions. For example, according to some example embodiments, the SSB can repeatedly signal and/or establish a periodicity for (and/or the start) of a cycle) wherein the level and/or number of active spatial elements decreases, as will described below in further detail. By applying this cycling, the network can save energy by reducing the level (where the levels of the active spatial elements represents at least one of a spatial element pattern or a number of spatial elements such that each of the plurality of partitions includes at least one of a different spatial element pattern or a different number of spatial elements compared to the other of the plurality of partitions) of spatial elements (such as antenna, antenna ports, active transceiver units and/or chains, etc.), but without also resulting in a loss of coverage for the subset of those UEs, or applications running on said UEs (hereafter collectively referred to as UEs), that require (or otherwise benefit from) higher beamforming gains.

Additionally, networks may undergo conditions wherein energy needs to be conserved. For example, if an emergency takes down the power grid, and/or the base stations start running on batteries, and the battery backup capacity of the BTS (base transceiver station) in at least some embodiments approximately ~4 hours, then that may be not typically sufficient for typical power usage, and as such a power outage may also result in a network outage. During such emergency situations, reducing the level and/or number of spatial elements can stretch the energy that is available to the network, without reducing the availability of network connection and/or coverage for, e.g., emergency communications.

The example embodiments of the present disclosure address these issues by repeatedly cycling through spatial element cycle sets (described in further detail below), thereby limiting energy expended on higher order spatial elements for UEs with lower spatial element requirements, while still supporting other UEs requiring those high order spatial elements. For example, although reducing the level and/or number of spatial elements can result in a significant reduction of network energy expenditure, such a reduction may also result in loss of coverage for some of the UEs due to the loss of beamforming gain. Therefore, although beamforming gain may not be needed by many UEs in that cell, it may be necessary to utilize a higher level and/or number of spatial elements, and consume additional network energy to ensure communication with other UEs that require a different level of antenna spatial elements (e.g., additional or different spatial elements and/or patterns, and/or beamforming gain). Additionally, repeatedly signalling UEs that a switch of the level and/or number of the spatial elements is about to occur introduces additional signalling overhead, and possibly additional opportunities for signalling error scenarios.

FIGS. 2 and 3 illustrate examples of repetition of cycling through spatial element cycle sets.

According to some example embodiments, a node (e.g., the RAN node 170 of FIG. 1), defines a one or more cycle sets for the spatial elements, to be repeatedly cycled through, enabling the node to effectively provide ongoing, concurrent, and/or overlapping support for multiple levels of antenna spatial elements for user equipment (UE) while avoiding repeated signaling and/or switching overhead while saving energy.

For example, according to some example embodiments, the node (e.g., a gNB) may target one (or more) UE and provide the spatial element cycle sets (SECS) (and/or parameters thereof) to the UE via, e.g., at least one of system information block (SIB), radio resource control (RRC), medium access control (MAC) control element (MAC CE), downlink control information (DCI), and/or the like. For example, in at least one embodiment, the communication between node and UE may be configured via RRC.

For example, in the present illustrated example, the node would provide to the UE that in each of the SECS (spatial element cycling sets) includes three partitions ([64, 32, 16]) of antenna spatial elements supported by the node. Thereafter, the UE would recognize that the SECS includes a cycle of three partitions including, respectively, 64, 32, and 16 active spatial elements. The presently illustrated example provides a ‘positive’ indication, which provides the number of active spatial elements, though in at least some embodiments, a negative indication may be provided wherein the number of inactive spatial elements is additionally, and/or alternatively indicated. Additionally, there may not be any indication at the time of the start of each partition and/or cycle as the timing of the switches have been pre-agreed e.g., via RRC. According to at least some embodiments, the node may set a synchronization signal block (SSB) in some and/or all the occurrences of a first partition of the cycle, which may be one of the partitions with the largest number of active spatial elements. In the case where the synchronization signal block (SSB) is in some subset of the occurrences of the aforementioned partition, the SSB might be, for example, in every other instance of that partition. According to some example embodiments, though the number of elements in each cycle is consistent within each cycle set, the pattern of active spatial elements may be the same and/or different between each partition and/or cycle set. More specifically, different spatial elements may be activated during different partitions and/or sets. For example, a change in the pattern of active spatial elements may represent (or include) a change in one or more of the following: one or more spatial element muting patterns; numbers or sets of active or muted spatial elements, one or more numbers or sets of (active or muted) antenna ports; one or more report or codebook or spatial configurations; one or more CSI-RS resources or resource sets; value(s) of one or more parameters or configurations for a CSI-RS resource or CSI-RS resource set; one or more energy (or power) levels or energy saving levels; numbers or sets of active or muted spatial elements; one or more numbers or sets of (active or muted) antenna ports; one or more report or codebook or spatial configurations; one or more CSI-RS resources or resource sets; value(s) of one or more parameters or configurations for a CSI-RS resource or CSI-RS resource sets; one or more energy/power levels or energy saving levels; one or more sets of transmission configuration indicator (TCI) states; and/or the like; one or more antenna panels. It is noted that two pattern may or may not be overlapping in terms of corresponding (active/muted) spatial elements. Hereafter the use of “level” and “pattern” (or spatial pattern) may be used interchangeably.

According to at least some embodiments, the same or different SECS configurations may be applied to different uplink (UL)/downlink (DL) signals and/or channels. The node may be may also be configured to indicate to the UE(s) which (UL)/(DL) signals and/or channels (such as physical downlink control channel (PDCCH), physical downlink shared channel (PDSCH), channel state information reference signal (CSI-RS), phase tracking reference signal (PT-RS), physical uplink control channel (PUCCH), physical uplink shared channel (PUSCH), sounding reference signal (SRS), physical random access channel (PRACH), etc.), and/or UL/DL resource (or resources) configurations (such as SPS configuration, configured-grant PUSCH configuration, CSI-RS or SRS configuration, etc.), the configuration of the one or more of the corresponding partitions which the resources apply to, etc. For example, the node may select one of plurality of SECS configurations for a UL/DL signal, channel, and/or resource; and may inform the UE (or UEs) which of the plurality of SECS configurations is selected and/or which of the UL/DL signals, channels, and/or resources the selected SECS is applied. Thereby, the UE(s) may be informed of which SECS configuration (among several ones) is applied and for which UL/DL signal and/or channel (and/or corresponding resource configuration) the SECS configuration of, e.g., at least one partition, would apply. According to at least some embodiments, such information may be provided via at least one of RRC, MAC, MAC CE, DCI, etc. For example, according to at least some embodiments, the information may be indicated to the UE(s) via at least one of MAC CE or DCI.

According to at least some embodiments, when a configuration or partition does not apply to a certain signal/channel, the UE may be specified (and/or configured to) assume that a default partition (and/or configuration) apply to this signal/channel. Alternatively, the UE may be specified or configured to not have any assumption, such that the UE uses normal and/or legacy operations for this channel/signal.

According to at least some embodiments, a spatial element cycle sets (SECS) may include additional partitions with a same number of active spatial elements as a previous partition and/or with sub-sets with different patterns of active spatial elements. For example, in an example different from the one illustrated, a SECS may indicate that the spatial elements supported by the node is [64, 16, 32, 16′], wherein a “16” partition appears twice for UE(s) requiring 16 antenna spatial elements which have more latency sensitive (e.g., guaranteed bit rate (GBR)) service requirements than other UEs and/or [64, 32, 32′, 16], wherein “32” and “32′” represent sub-sets in the “32” partition which include the activation of different (but potentially overlapping) sub-sets of the spatial elements. In these examples, the 16′ and 32′ may have the same or a different pattern of active spatial elements as the 16 and 32.

According to at least some example embodiments, the SECS may also include a discontinuous transmission (DTX) interval in (or at the end of) the cycle set, such that the SECS indicates that the spatial elements supported by the node is, e.g., [64, 16, 32, 0].

According to at least some example embodiments, the SECS may also include a null interval in the cycle set, such that the SECS does not indicate any information on the spatial elements supported by the node during that partition, e.g., [64, 16, 32, NULL]; and the UE may or may not have any assumption (e.g., based on gNB configuration) regarding which spatial elements are active (or muted) for a NULL partition.

The UE may also be informed by, e.g., the node (e.g., the RAN node 170 of FIG. 1), of the duration of each the partitions. For example, the node may indicate that the Spatial Partition Duration (SPD) is, e.g., [1, 2, 4] based on a standardized Spatial Partition Unit (SPU) of, e.g., n slots or symbols (wherein n represents an integer). It should be understood, therefore, in the presently illustrated example, if n is, e.g., two slots, the SECS may include three respective partitions (1, 2, and 4) wherein the first partition includes 64 spatial elements active for the duration of two slots (1×2), the second partition includes 32 inactive and 32 active spatial elements for a duration of 4 slots (2×2), and the third partition includes 48 inactive and 16 active spatial elements a duration of 8 slots (4×8). Additionally, according to at least some embodiments, the network may provide a minimum duration as a set value for a partition, referred to hereafter as a Minimum Spatial Partition Duration. This Minimum Spatial Partition Duration may be set to allow for the complete transmission of, e.g., the SSB, and may be applied, e.g., to only the partition (instances) with the largest number of active spatial elements, and/or to some (or all) of the partitions. It should be understood that this example is provided only as an illustrative example, and that the specific duration of each unit and SPD is not particularly limited and may be provided per partition, and/or adjusted based on the demands of the network.

In the case where the synchronization signal block (SSB) is in some subset of the instances of the aforementioned partition with the largest number of active spatial elements, the SSB might be, for example, in every other instance of that partition.

Based on the provided spatial element cycle sets (SECS), spatial partition duration (SPD), and spatial partition unit (SPU), the UE may calculate and determine the antenna spatial elements utilizes during the i^{th} Partition of the Spatial Element Cycle Set and the i^{th} Partition duration equals the SPU*SPD (+Minimum Spatial Partition Duration). According to some example embodiments, the node may be configured to not set the partition (instance) containing the SSB to a duration less than the Minimum Spatial Partition Duration. For example:

Thereby, the energy requirements of the network may be reduced without requiring persistent updates and/or additional signalling. Further, legacy UEs, which may require higher beamforming gains, can coexist with the above approach. For example, based on the illustrated example, with SSB based on a 64 spatial elements transmission, the legacy UEs are informed using legacy UE signaling during the 64 spatial elements partition, and the node schedules the legacy UEs during only the 64 spatial element partition, and not during the 32 or 16 spatial element partitions. Additionally, according to some example embodiments, the node schedules UE within the partition appropriate for that UE's spatial conditions. For example, to avoid using more spatial elements than needed when communicating with a particular UE, the node schedules the UE based on the UE's need for at that level and/or number of spatial elements. The node may also consider additional factors, such as the quality of service (QoS), delay constraints, etc., during the scheduling. Additionally, because the configuration of the node will not always perfectly match the demands of the UEs, the node can, for example, schedule UEs estimated to need only a smaller sub-set of the spatial elements (e.g., 32 spatial elements) during the higher (e.g., 64) spatial elements partitions.

According to at least some embodiments, the configuration may be set when the UE initially connects to the network (and/or to the node), a grant is provided to the UE, and/or in response to a status change (e.g., when the network switches to battery power).

Additionally, according to at least some example embodiments, the node may enable an update to the cycle (and/or at least some of the parameters therefor) via, e.g., at least one of SIB, RRC, MAC-CE, DCI, and/or the like. For example, at least one of the SECS, SPU, SPD, and/or minimum partial partition duration, may be updated.

For example, as illustrated in FIG. 3, an indication that a modification to the SECS is scheduled, wherein in the duration of the 32 and 16 partitions are to be modified, may be provided to the UEs, and the network may initiate the modification.

According to at least some example embodiments, MAC CE and/or DCI (e.g., with at least one dedicated GC (group common) RNTI, in order to target multiple UEs at a time) configures, indicates, and/or updates (some or all) the SECS and/or (some or all) the SPD (which may be most likely to change during short cycles).

According to some examples, such an update may occur when the node detects that a difference between the current SECS and the short-term objective is sufficiently large (e.g., greater than a tolerance threshold), as described in greater detail below.

FIG. 4 illustrates an example of signaling between user equipment (“UE”) and a base station (gNB).

According to some example embodiments, in step S101 the gNB provides the configuration of the spatial partition unit (SPU), and, if applicable, the Minimum spatial partition duration (SPD) of the spatial element cycle set (SECS) to the UEs. According to at least one example, the configuration is provided via, at least one of SIB, RRC, and/or MAC-CE. In step S102, the gNB provides the configuration of SECS to the UEs. Though illustrated as separate steps, in at least some embodiments, steps S101 and S102 may be provided separately, and/or may be concurrently. Additionally, according to at least some embodiments, step S101 may be omitted in networks wherein the SPU and Minimum SPD data are alternatively provided to and stored by the UEs (e.g., through network updates and/or the like).

In steps S103 and S104, the gNB may cycle (and/or continue to cycle) through the SECS and the UE may utilize at least a portion of the SECS.

In step S105, the gNB may monitor the current SECS, and may compare the present conditions thereof to a short term observational goal. For example, the short term observational goals may be and/or include a reference demand representing, e.g., an expected demand for the relevant period of time or portions of the SECS. If a difference between the present conditions and the short term observational goal is greater than a tolerance threshold (for example, a latency is greater than a permitted tolerance, an SPU is not being fully utilized, gNB battery drain is too great, etc.), the gNB may update the SECS, and, in step S106, provide the second configuration to the UE. Then, during step S107, the gNB and UEs may operate based on the second configuration.

For example, after the UE receive the SECS configuration (or at least the corresponding partitions), the UE may use the related cycle information and corresponding spatial partitions (and the respective periods in time) to receive (measures, decode, etc.) signals and channels such as CSI-RS, PDSCH, PDCCH etc; and also to transmit unlink UL signals and channels such as physical uplink control channel (PUCCH), physical uplink shared channel (PUSCH), software requirements specification (SRS), etc. For example, in the examples illustrated in FIGS. 2 and 3, during the periods corresponding to the 32 active spatial elements partition, the UE assumes that e.g., the CSI-RS has all the ports active and/or available for measurements, transmission, and/or reception; and in the period corresponding to the subset of 16 active spatial elements partition, the UE assumes that, e.g., the CSI-RS only has the subset of 16 ports active and/or available for measurements, transmission, and/or reception.

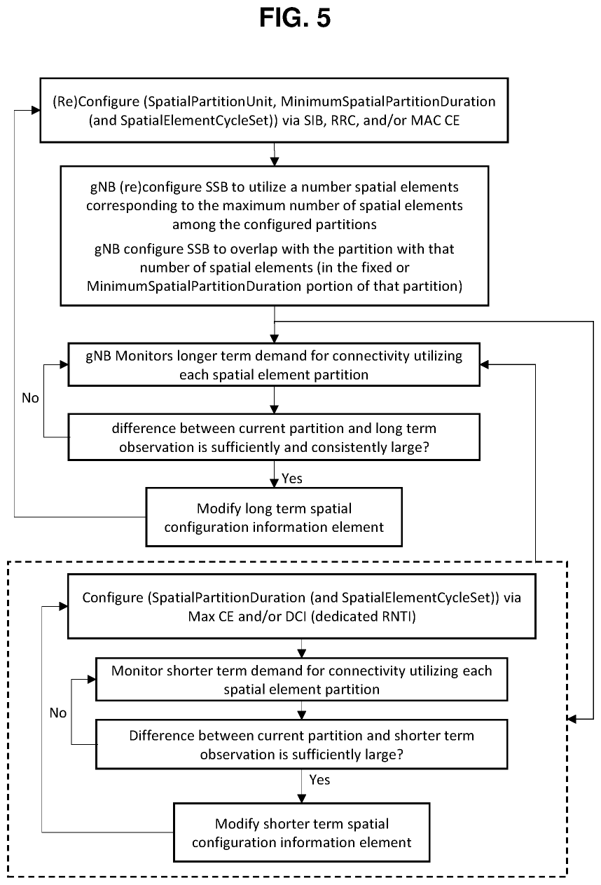

FIG. 5 is a flow chart illustrating a method of establishing the operation of components in a base station.

With regard to FIG. 5, in step S201, the gNB may provide the present configuration of the spatial element cycle set (SECS) to the UEs. Step S201 may be, the same as (or substantially similar to) step S101, and therefore repeat descriptions thereof are omitted for brevity. The following description also refers to adjustments to the number of active spatial elements for brevity, but the examples are not limited thereto, and, as indicated above, the level of the spatial elements may be additionally and/or alternatively applied.

In step S202, the gNB may configure the SSB to utilize a number of spatial elements corresponding to the number of active spatial elements included in the partition with the maximum number of active spatial elements and to overlap the SSB with that partition. The SSB may define the overlapping partition as the start of the SECS. The gNB may also select a partition such that SECS is consistent between cycles. According to some example embodiments, if the partition with the maximum number of active spatial elements includes the Minimum Spatial Partition Duration, the SSB may overlap with the Minimum Spatial Partition Duration.

The gNB may be configured to monitor the short and long term demands and performance for the network. In one embodiment, the short term observation may correspond to an observation of the level of need for different spatial partitions applicable during this particular cycle of the partition, and/or the long term observation may correspond to an observation of the level of need for different spatial partitions which is applicable across multiple cycles and/or based on the observation of the level of need for different spatial partitions across multiple prior cycles. For example, in the case of the short term observation in step S203-01, the gNB may set the SECS configuration and/or provide the configuration of SECS to the UEs; the gNB may, in steps S203-05 and S203-10, monitor the in real-time demands for each of the partitions, and may determine whether a difference the actual performance and the short term observations (or expectation) is greater than a tolerance threshold.

In the case wherein the difference is within the threshold (e.g., wherein the partitions are meeting but not exceeding the demands), the gNB may maintain the present configuration. In the case wherein the short term demands are not being met and/or the duration of partition exceeds the demands, the gNB may, in step S203-15, modify the short term spatial configuration of the SECS. For example, the gNB may adjust at least one of the SPDs, the number of partitions, and/or the number active elements in the partitions.

Additionally, in step S204-01, the gNB may monitor the longer term demands for the network and may determine whether a difference the actual performance and the long term demands is greater than a longer term tolerance threshold. For example, the gNB may monitor the actual performance and the long term demands for patterns, and, e.g., if step S203-15 occurs too many times during a monitoring period, occurs at predictable times, expected battery duration is declining too rapidly, etc., the gNB may modify the long term spatial configuration of the SECS. For example, the gNB may adjust at least one of the SPDs, SPU, the minimum SPD, the number of partitions, and/or the number active elements in the partitions and/or may schedule a change based on past patterns. For example, during predictable periods of low activity, the gNB may schedule longer SPDs and/or SPUs for partitions with fewer active units.

Thereby, by setting and providing the SECS to UEs, the gNB may effectively provide concurrent (and/or near simultaneous) support for multiple levels of antenna spatial elements across an “RF diverse” set of UEs while avoiding overhead associated with repeated signalling overhead, saving energy through frequent use of reduced levels of antenna spatial elements, and still allowing some flexibility to adapt the partitions in response to changing RF/UE spatial conditions, traffic fluctuations, and energy saving requirements.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify herein, specify the presence of stated features, integers, steps, operations, elements, and/or components and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing user equipment, base stations, eNBs, RRHs, gNBs, femto base stations, network controllers, computers, Central Units (Cus), ng-eNBs, other radio access or backhaul network elements, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently, or simultaneously. In addition, the order of the operations may be re-arranged. A process may be terminated when its operations are completed but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing, or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory, and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, base stations, eNBs, RRHs, gNBs, femto base stations, network controllers, computers, Central Units (Cus), ng-eNBs, other radio access or backhaul network elements, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1-19. (canceled)

20. A node for operation in a network, the node comprising:
at least one processor; and
at least one memory storing instructions that, when executed by the at least one processor, cause the node at least to perform:
setting at least one configuration of a spatial element cycle set such that the spatial element cycle set includes a plurality of partitions, and such that each partition of the plurality of partitions includes a level of active spatial elements different from a level of the active spatial elements in at least one other of the plurality of partitions;
repeatedly cycling through the spatial element cycle set; and
transmitting parameters for the configuration of the spatial element cycle set to user equipment (UE).

21. The node of claim 20, wherein
the setting of the configuration of the spatial element cycle set includes setting respective spatial partition durations for the plurality of partitions, and
the transmitting the parameters to the UE includes transmitting the respective spatial partition durations to the UE.

22. The node of claim 21, wherein the setting the spatial partition duration includes allocating a number of slots for each partition.

23. The node of claim 20, wherein the transmitting the parameters is provided via at least one of system information block (SIB), radio resource control (RRC), medium access control control element (MAC CE), or downlink control information (DCI).

24. The node of claim 20, wherein the level of the active spatial elements represents at least one of a spatial element pattern or a number of spatial elements such that each of the plurality of partitions includes at least one of a different spatial element pattern or a different number of spatial elements compared to the other of the plurality of partitions.

25. The node of claim 20, wherein a majority of the plurality of partitions includes a number of the active spatial elements less than a total number of spatial elements available.

26. The node of claim 20, wherein the instructions, when executed by the at least one processor, further cause the node at least to perform:
monitoring the plurality of partitions;
modifying the parameters of the spatial element cycle set based on a result of the monitoring; and
transmitting the modified parameters for the configuration of the spatial element cycle set to the UE,
wherein the modifying the parameters includes at least one of modifying a spatial partition duration of at least one of the plurality of partitions, modifying the number of partitions, or modifying the number of the active spatial elements in at least one of the partitions.

27. The node of claim 26, wherein
the monitoring the demand includes monitoring demand for connectivity in each of the plurality of partitions and determining whether a difference between the demand and a reference demand is within a threshold tolerance, and
the modifying the parameters is initiated when the difference is determined to be greater than the threshold tolerance.

28. The node of claim 26, wherein the transmitting the modified parameters is provided via at least one of system information block (SIB), radio resource control (RRC), medium access control control element (MAC CE), or downlink control information (DCI).

29. The node of claim 20, wherein the instructions, when executed by the at least one processor, further cause the node at least to perform:
scheduling the UE to a plurality of partitions based on demands of the UE and conditions of the network.

30. The node of claim 20, wherein
the setting the configuration of the spatial element cycle set includes scheduling a synchronization signal block (SSB) for a partition of the plurality of partitions with a largest number of the active spatial elements, and
the repeatedly cycling through the spatial element cycle set includes overlapping the SSB with the partition with the largest number of the active spatial elements.

31. The node of claim 20, wherein
the setting of the configuration of the spatial element cycle set includes scheduling a synchronization signal block (SSB) for a partition, of the plurality of partitions, with a largest number of the active spatial elements, and
a remainder of the plurality of the partitions included in the spatial element cycle set each including fewer of the active spatial elements compared to the partition with the SSB.

32. The node of claim 20, wherein at least one of the plurality of partitions includes a first sub-set and a second sub-set such that, while the number of active elements remains consistent during the partition, the active elements during the first sub-set are different from the active elements during the second sub-set.

33. The node of claim 20, wherein the scheduling the UE includes scheduling the UE to a partition, of the plurality of partitions, with a number of active elements equal to or greater than the UE's beamforming gains demand.

34. The node of claim 20, wherein the setting the configuration of the spatial element cycle set includes reducing an energy cost of the network when the node is operating on battery power.

35. The node of claim 20, wherein the instructions, when executed by the at least one processor, further cause the node at least to perform:
indicating, to the UE, at least one of an uplink (UL)/downlink (DL) signal, a UL/DL channel, a UL/DL resource, a configuration of the UL/DL signal, a configuration of the UL/DL channel, a configuration of the UL/DL resources, or the configuration of at least one partition of the plurality of partitions applied to the UL/DL signal, the UL/DL channel, or the UL/DL resource.

36. The node of claim 20, wherein the instructions, when executed by the at least one processor, further cause the node at least to perform:
specifying to the UE at least one signal or channel, of a plurality of signals or channel, for which the spatial element cycle set applies.

37. The node of claim 36, wherein specifying to the UE at least one of the signal or the channel for which the spatial element cycle set applies includes initiating at least one of a default or normal configuration for at least one signal or channel of the plurality of signals or channels for which the spatial element cycle set does not apply.

38. A method of operating a node in a network, the method comprising:
setting at least one configuration of a spatial element cycle set such that the spatial element cycle set includes a plurality of partitions, and such that each partition of the plurality of partitions includes a level of active spatial elements different from a level of the active spatial elements in at least one other of the plurality of partitions;
repeatedly cycling through the spatial element cycle set; and
transmitting parameters for the configuration of the spatial element cycle set to a user equipment (UE).

39. A non-transitory computer readable storage medium, comprising instructions, which when executed by at least one processor, cause a node in a network to at least perform:
setting at least one configuration of a spatial element cycle set such that the spatial element cycle set includes a plurality of partitions, and such that each partition of the plurality of partitions includes a level of active spatial elements different from a level of the active spatial elements in at least one other of the plurality of partitions;
repeatedly cycling through the spatial element cycle set; and
transmitting parameters for the configuration of the spatial element cycle set to a user equipment (UE).
